(19) United States
(12) Patent Application Publication
(10) Pub. No.: US 2026/0023808 A1
(43) Pub. Date: Jan. 22, 2026

(54) RECORDING MEDIUM, NUMBER-OF-LOOPS ADJUSTMENT METHOD, AND INFORMATION PROCESSING DEVICE

(71) Applicant: Fujitsu Limited, Kawasaki-shi (JP)

(72) Inventor: Hong GAO, Kunitachi (JP)

(73) Assignee: Fujitsu Limited, Kawasaki-shi (JP)

(21) Appl. No.: 19/238,578

(22) Filed: Jun. 16, 2025

(30) Foreign Application Priority Data
Jul. 17, 2024 (JP) 2024-113973

(51) Int. Cl. G06F 17/11; B82Y 35/00

(52) U.S. Cl. CPC G06F 17/11; B82Y 35/00

(57) ABSTRACT

A computer-readable recording medium stores therein a number-of-loops adjustment program for causing a computer to execute a process including: determining a maximum number-of-loops when a quantum chemical calculation using a configuration interaction method is executed for a substance under analysis, the maximum number-of-loops being determined based on: a first energy value obtained by the quantum chemical calculation using a first coupled cluster method for the substance under analysis, a second energy value obtained by the quantum chemical calculation using a second coupled cluster method having a different maximum excitation count from the first coupled cluster method for the substance under analysis, and a number-of-loops of the first coupled cluster method when the first energy value is obtained.

### CROSS REFERENCE TO RELATED APPLICATIONS

This application is based upon and claims the benefit of priority of the prior Japanese Patent Application No. 2024-113973, filed on Jul. 17,2024, the entire contents of which are incorporated herein by reference.

### FIELD OF THE INVENTION

The embodiments discussed herein are related to a recording medium, a number-of-loops adjustment method, and an information processing device.

### BACKGROUND OF THE INVENTION

Quantum chemical calculation is a technique for analyzing molecular structures, material properties, reactivities, and the like by calculating the behaviors of atoms and electrons. For example, a configuration interaction (CI) method may be used for the quantum chemical calculation. The CI method is a quantum chemical calculation method based on the principle of interactions occurring between electron configurations in atoms or molecules.

As a prior art, there is a method of calculating the overlap integral value between the molecular orbitals included in each of multiple molecular orbital pairs, which are combinations of two molecular orbitals included in multiple molecular orbitals of a molecule under analysis, and determining a first molecular orbital to be included in an active space orbital group in a quantum chemical calculation based on the overlap integral value of each of the multiple molecular orbital pairs. For an example, refer to International Publication No. WO 2022/097298.

### SUMMARY OF THE INVENTION

According to an aspect of an embodiment, a computer-readable recording medium stores therein a number-of-loops adjustment program for causing a computer to execute a process including: determining a maximum number-of-loops when a quantum chemical calculation using a configuration interaction method is executed for a substance under analysis, the maximum number-of-loops being determined based on: a first energy value obtained by the quantum chemical calculation using a first coupled cluster method for the substance under analysis, a second energy value obtained by the quantum chemical calculation using a second coupled cluster method having a different maximum excitation count from the first coupled cluster method for the substance under analysis, and a number-of-loops of the first coupled cluster method when the first energy value is obtained.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory view depicting one example of a number-of-loops adjustment method according to an embodiment.

FIG. 2 is an explanatory view depicting a relationship between convergence condition judgment and number of loops.

FIG. 3 is an explanatory view depicting an example of an information processing system 300.

FIG. 4 is a block diagram depicting an example of a hardware configuration of an information processing device 100.

FIG. 5 is a block diagram depicting an example of a functional configuration of the information processing device 100.

FIG. 6 is an explanatory view depicting an example of stored contents of a coefficient table 600.

FIG. 7 is an explanatory view depicting a calculation example of a value of a coefficient k corresponding to a difference interval.

FIG. 8 is a flowchart depicting an example of a procedure of a number-of-loops adjustment process of the information processing device 100.

FIG. 9 is a flowchart depicting an example of a specific processing procedure of a quantum chemical calculation using an FCI method.

FIG. 10 is an explanatory view depicting an example of a reduction in an execution time when the present number-of-loops adjustment method is applied.

FIG. 11 is an explanatory view depicting an example of a reduction in the execution time when the present number-of-loops adjustment method is applied.

### DESCRIPTION OF THE INVENTION

First, problems associated with the conventional techniques are discussed. In the prior art, it is difficult to properly determine an upper limit of the number of loops in quantum chemical calculations using a configuration interaction (CI) method, leading to a problem of increases in the time required for execution of quantum chemical calculations using a CI method.

Embodiments of a computer-readable recording medium, a number-of-loops adjustment method, and an information processing device according to the present invention are described in detail with reference to the accompanying drawings.

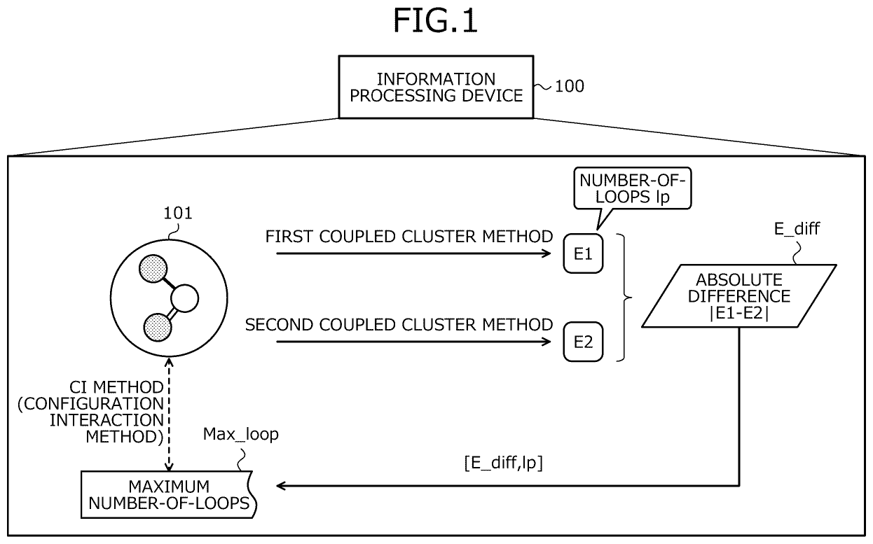

FIG. 1 is an explanatory view depicting one example of a number-of-loops adjustment method according to an embodiment. In FIG. 1, an information processing device 100 is a computer that determines a maximum number of loops when performing a quantum chemical calculation using a configuration interaction (CI) method for a substance under analysis. The substance under analysis is a substance that is the subject of analysis by quantum chemical calculation.

The substance under analysis is, for example, an atom or a molecule. The maximum number-of-loops is an upper limit of the number of loops (repetition count) when calculating an energy value by iterative calculation in the quantum chemical calculation using a CI method. The CI method is a quantum chemical calculation method. The quantum chemical calculation is a technique for analyzing molecular structures, material properties, reactivities, and the like.

For example, in the quantum chemical calculation, the distance and angle between each atom are calculated to specify a molecular structure to understand the shape and angle at which the molecules are bonded. In addition, in the quantum chemical calculation, reactivity is analyzed to understand the ease and mechanism of chemical reactions, such as how much energy is required to dissociate atoms.

Among CI methods, there is a full configuration interaction (FCI) method for finding an exact solution. The FCI method is sometimes used as a standard of accuracy for other quantum chemical calculation methods. For example, due to the recent development of quantum computers, the variational quantum eigensolver (VQE) method has become important, and the FCI method is sometimes used to evaluate the VQE method.

Here, the quantum chemical calculation is theoretically solving the exact solution of the Schrodinger equation. However, it is difficult to directly solve the Schrodinger equation. For example, in the FCI method, a wave function is approximated by a linear combination of multiple Slater determinants, so that if the Schrodinger equation is directly solved, the size of the Hamiltonian matrix becomes huge.

For this reason, for example, the Davidson iteration method is often used as a solution method for quantum chemical calculations using the FCI method. The Davidson iteration method is a method that uses a subspace Hamiltonian matrix instead of a full-size Hamiltonian matrix. In the Davidson iteration method, a subspace Hamiltonian matrix is constructed by iterative calculation of Y=HX, and the eigenvalues of the Hamiltonian matrix are updated.

X is a trial vector. H is a Hamiltonian operator corresponding to the subspace. The Davidson iteration method repeatedly executes iterative calculations until a predetermined convergence condition is satisfied or the maximum number of loops is reached. When the number of loops reaches the maximum number of loops, the iterative calculation ends even if the convergence condition is not satisfied.

In the conventional Davidson iterative method, it is difficult to determine how many times the iterative calculation is performed to converge, so an excessively large, fixed value (for example, 100) is often set as the maximum number of loops. However, there are cases where the iterative calculation does not converge even if it is performed up to the maximum number of loops.

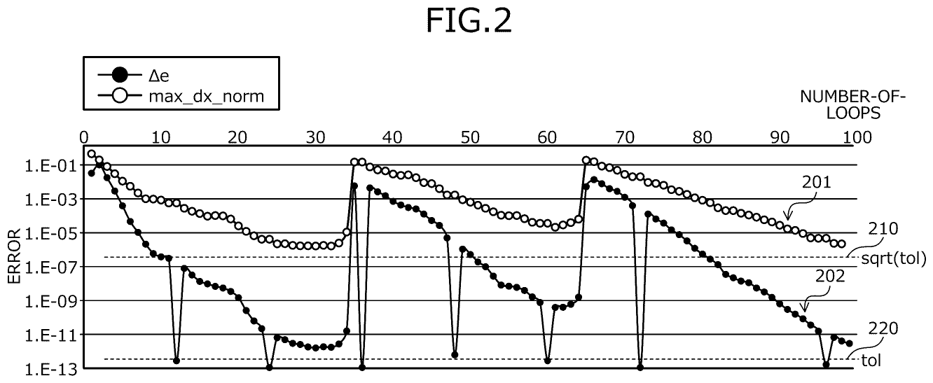

With reference to FIG. 2, a case is described where the quantum chemical calculation using the FCI method is performed for a certain molecule (for example, SiC) by the conventional Davidson iterative method. Here, the maximum number of loops is set to “100 times”.

FIG. 2 is an explanatory view depicting a relationship between convergence condition judgment and the number of loops. In FIG. 2, a graph 201 depicts the change in max_dx_norm (∘ in FIG. 2) depending on the number of loops. A graph 202 depicts the change in Δe (● in FIG. 2) according to the number of loops. max_dx_norm is the normalization result of the residual vector based on the trial vector X.

Δe is an absolute difference of the eigenvalue e of the Hamiltonian matrix. max_dx_norm and Δe are values to be compared with the convergence condition. Here, it is assumed that the convergence condition is satisfied when “Δe<tol” and “max_dx_norm<sqrt(tol)”. In FIG. 2, a line 210 indicates sqrt(tol). A Line 220 indicates tol.

In the example of FIG. 2, even when the iterative calculation is performed up to the maximum number of loops (100 times), the convergence condition is not satisfied. As described, when the calculation does not converge even when performed up to the maximum number of loops, there is a problem in that the larger the maximum number of loops is, the more wasteful processing occurs, which leads to an increase in the execution time required for the quantum chemical calculation. On the other hand, when the maximum number of loops is made too small, it becomes difficult to maintain the accuracy of the quantum chemical calculation.

Here, it is assumed that the convergence condition is likely to be satisfied when the number of loops is about 30, and the calculation result obtained at that time is almost the same as the calculation result obtained by executing the calculation up to the maximum number of loops. In this case, when the maximum number of loops can be set to about 30, it is possible to reduce unnecessary processing and shorten the execution time required for the quantum chemical calculation.

Thus, in the present embodiment, a number-of-loops adjustment method is described for determining the maximum number of loops when using the CI method, using the number of loops when calculating energy values using the coupled cluster method, which tends to have a shorter execution time than the configuration interaction (CI) method. Here, an example of processing by the information processing device 100 is described.

The information processing device 100 determines a maximum number-of-loops Max_loop when performing quantum chemical calculation using the configuration interaction (CI) method for a molecule-under-analysis 101, based on a first energy value E1, a second energy value E2, and a number-of-loops Ip. Here, the molecule-under-analysis 101 is an example of a substance under analysis. The first energy value E1 is an energy value obtained by the quantum chemical calculation using a first coupled cluster method for the molecule-under-analysis 101.

The second energy value E2 is an energy value obtained by the quantum chemical calculation using a second coupled cluster method. Both the first and second coupled cluster methods are coupled cluster methods (CC methods). Like the CI method, a coupled cluster method is a quantum chemical calculation method and is a technique that uses iterative calculation.

The first and second coupled cluster methods have different maximum excitation counts, that is, how many electronic excitations are considered. The first coupled cluster method is, for example, the coupled cluster singles and doubles (CCSD) method. The CCSD method considers up to two electronic excitations.

The second coupled cluster method is, for example, the CCSD parenthesis triples (CCSD(T)) method. CCSD(T) takes into account up to three electronic excitations. The number-of-loops Ip is the number of loops of the first coupled cluster method when the first energy value E1 is obtained for the molecule-under-analysis 101.

For example, let the first coupled cluster method and the second coupled cluster method be the “CCSD method” and the “CCSD(T) method”, respectively. In this case, the first energy value E1 is the energy value when the convergence condition is satisfied in the quantum chemical calculation using the CCSD method. The second energy value E2 is the energy value when the convergence condition is satisfied in the quantum chemical calculation using the CCSD(T) method. The number-of-loops Ip is the number-of-loops when the convergence condition is satisfied in the quantum chemical calculation using the CCSD method. The number-of-loops Ip may be the number-of-loops when the convergence condition is satisfied in the quantum chemical calculation using the CCSD(T) method.

For example, the information processing device 100 determines the maximum number-of-loops Max_loop for the molecule-under-analysis 101 based on an absolute difference E_diff of the first energy value E1 and the second energy value E2 and the number-of-loops lp.

Here, the absolute difference E_diff is the difference of the energy values obtained using two coupled cluster methods with different maximum excitation counts and corresponds to the excitation energy value. For example, when the first coupled cluster method is the “CCSD method” and the second coupled cluster method is the “CCSD(T)”, the absolute difference E_diff corresponds to the energy value of three electron excitations.

The absolute difference E_diff can be an index for determining whether the electrons are activated. For example, when the molecule-under-analysis 101 is an electron-activated molecule, it can be said that it is difficult to converge with a small number of loops. On the other hand, when the molecule-under-analysis 101 is a stable molecule, it can be said that convergence is easy even with a small number of loops.

Thus, it can be said that the number of loops at the time of convergence depends on the properties of the molecule. In addition, the first coupled cluster method (for example, the CCSD method) is a type of iterative method, similar to the CI method (configuration interaction method). Therefore, for the same molecule, it can be said that the number-of-loops Ip at the time of convergence in the quantum chemical calculation using the first coupled cluster method is correlated with the number of loops in the quantum chemical calculation using the CI method. The number of loops in the quantum chemical calculation using the CI method is, for example, the number of loops when the quantum chemical calculation using the CI method converges, or the number of loops that can obtain a result with the same accuracy as the number of loops when the calculation converges.

The calculation time of the first coupled cluster method tends to be significantly shorter than the calculation time of the CI method (for example, the FCI method). For example, the calculation time of the CCSD method is about several seconds, whereas the calculation time of the FCI method is about several hours. It can be said that the calculation time of the CCSD method is small enough to be negligible compared to the calculation time of the FCI method. The calculation time of the CCSD(T) method is also about several tens of seconds, which is shorter than the calculation time of the FCI method.

Thus, the information processing device 100 determines the maximum number-of-loops Max_loop in the CI method according to the absolute difference E_diff based on the number-of-loops Ip. For example, the information processing device 100 may determine the maximum number-of-loops Max_loop based on the number-of-loops Ip so that the larger the absolute difference E_diff is, the larger the value of the maximum number-of-loops Max_loop is. Also, the information processing device 100 may determine the maximum number-of-loops Max_loop based on the number-of-loops Ip so that the smaller the absolute difference E_diff is, the smaller the value of the maximum number-of-loops Max_loop is.

As described, according to the information processing device 100, it is possible to adjust the maximum number-of-loops Max_loop in the quantum chemical calculation using the CI method (configuration interaction method) for the molecule-under-analysis 101. For example, the information processing device 100 can adjust the maximum number-of-loops Max_loop so that it is not too large, thereby shortening the execution time required for the quantum chemical calculation using the FCI method. Moreover, the information processing device 100 can maintain the accuracy of the quantum chemical calculation using the FCI method by adjusting the maximum number-of-loops Max_loop so that it is not too small.

Furthermore, the information processing device 100 may execute the quantum chemical calculation using the CI method (configuration interaction method) for the molecule-under-analysis 101, with the determined maximum number-of-loops Max_loop as the upper limit value of the number-of-loops. This enables the information processing device 100 to shorten the execution time required for the quantum chemical calculation while maintaining the accuracy of the quantum chemical calculation using the configuration interaction method (CI method).

The quantum chemical calculation using the CI method may be executed at a computer other than the information processing device 100. For example, the information processing device 100 may output the maximum number-of-loops Max_loop determined for the molecule-under-analysis 101 to another computer. In this case, the other computer can execute the quantum chemical calculation using the CI method for the molecule-under-analysis 101, with the output maximum number-of-loops Max_loop as the upper limit of the number-of-loops.

In addition, the information processing device 100 may use the ratio between the first energy value E1 and the second energy value E2 instead of the absolute difference E_diff when determining the maximum number-of-loops Max_loop. For example, the information processing device 100 determines the maximum number-of-loops Max_loop in the CI method according to the ratio between the first energy value E1 and the second energy value E2, based on the number-of-loops Ip.

For example, the information processing device 100 may determine the maximum number-of-loops Max_loop based on the number-of-loops Ip according to the ratio between the first energy value E1 and the second energy value E2, so that the value of the maximum number-of-loops Max_loop becomes larger as the second energy value E2 becomes larger relative to the first energy value E1.

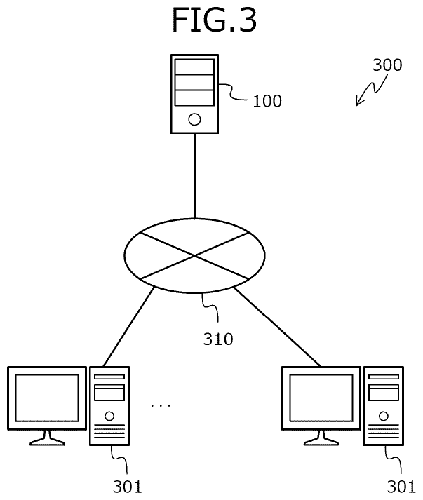

An example of an information processing system 300 to which the information processing device 100 depicted in FIG. 1 is applied is described next with reference to FIG. 3.

FIG. 3 is an explanatory view depicting an example of the information processing system 300. In FIG. 3, the information processing system 300 includes the information processing device 100 and a client device 301.

In the information processing system 300, the information processing device 100 and the client device 301 communication with each other via a wired or wireless network 310. The network 310 is, for example, a local area network (LAN), a wide area network (WAN), the Internet, etc.

The information processing device 100 is a computer capable of performing quantum chemical calculations using the CI method. The CI method is, for example, the FCI method. The CI method is called differently depending on how many electronic excitations are considered, as with the CC method (Coupled Cluster Method). The FCI method considers all electronic excitations. For example, the CIFDTQ method may be used as the CI method. The CIFDTQ method considers up to four electronic excitations.

The information processing device 100 obtains a processing request requesting the execution of the quantum chemical calculation using the CI method. The processing request includes information specifying a substance under analysis. The substance under analysis is an atom or molecule that is the subject of analysis by the quantum chemical calculation. For example, the information processing device 100 obtains the processing request by receiving the processing request from the client device 301. For example, the information processing device 100 may obtain the processing request by receiving an input of the processing request based on an operation input by a user.

The information processing device 100 executes the quantum chemical calculation using the CI method for the substance under analysis in response to the received processing request. At this time, the information processing device 100 determines the maximum number-of-loops Max_loop of the quantum chemical calculation using the CI method and executes the quantum chemical calculation with the determined maximum number-of-loops Max_loop as the upper limit of the number-of-loops.

The information processing device 100 outputs the execution result of the quantum chemical calculation using the CI method. For example, the information processing device 100 may transmit the execution result to the client device 301. The information processing device 100 is, for example, a server or a personal computer (PC).

The client device 301 is a computer used by a user of the information processing system 300. The client device 301 generates a processing request requesting the execution of the quantum chemical calculation using the CI method and transmits the generated processing request to the information processing device 100. The processing request is generated, for example, based on an operation input by the user.

The client device 301 receives the execution result of the quantum chemical calculation using the CI method. The client device 301 outputs the received execution result so that the user can refer to the execution result. The client device 301 is, for example, a PC, a tablet terminal, a smartphone, etc.

While a case has been described where the information processing device 100 is a computer different from the client device 301, this is not limitative. For example, the information processing device 100 may have a function as the client device 301 and also operate as the client device 301.

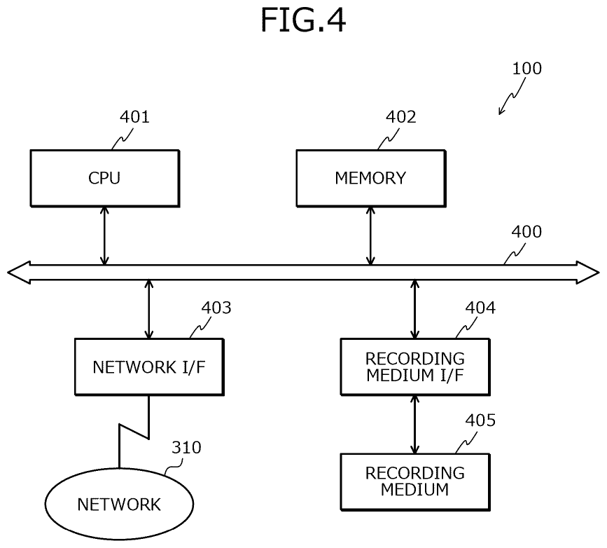

Next, with reference to FIG. 4, an example of a hardware configuration of the information processing device 100 is described.

FIG. 4 is a block diagram depicting an example of a hardware configuration of the information processing device 100. In FIG. 4, the information processing device 100 has a central processing unit (CPU) 401, a memory 402, a network interface (I/F) 403, a recording medium I/F 404, and a recording medium 405. Further, the components are coupled to each other by a bus 400.

Here, the CPU 401 governs overall control of the information processing device 100. The memory 402 includes, for example, a read-only memory (ROM), random access memory (RAM), and a flash ROM. In particular, for example, the flash ROM and the ROM store various types of programs and the RAM is used as work area of the CPU 401. Programs stored in the memory 402 are loaded onto the CPU 401, whereby encoded processes are executed by the CPU 401.

The network I/F 403 is coupled to a network 310 through a communications line and communicates with other computers on the network 310. Further, the network I/F 403 administers an internal interface with the network 310 and controls the input and output of data from other computers. The network I/F 403 is, for example, a modem or a LAN adapter.

The recording medium I/F 404, under control of the CPU 401, controls the reading and writing of data with respect to the recording medium 405. The recording medium I/F 404 is, for example, a disk drive, a solid-state drive (SSD), a universal serial bus (USB) port, and the like. The recording medium 405 is a nonvolatile memory storing data written thereto under the control of the recording medium I/F 404. The recording medium 405 is, for example, a disk, a semiconductor memory, a USB memory, and the like. The recording medium 405 may be removable from the information processing device 100.

In addition to the above components, the information processing device 100 may have, for example, a keyboard, a mouse, a display, a printer, a scanner, a microphone, a speaker, etc. Further, the information processing device 100 may have the recording medium I/F 404 and the recording medium 405 in plural. Further, the information processing device 100 may omit the recording medium I/F 404 and the recording medium 405.

An example of a hardware configuration of the client device 301 is the same as the example of the hardware configuration of the information processing device 100 depicted in FIG. 4 and thus, description thereof is omitted.

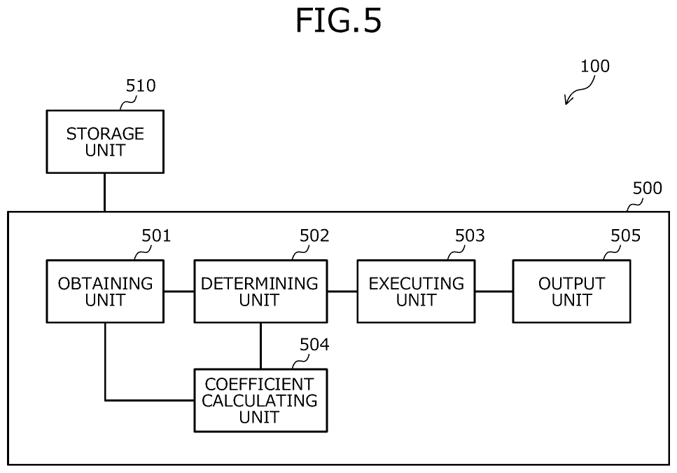

An example of a functional configuration of the information processing device 100 is described next with reference to FIG. 5.

FIG. 5 is a block diagram depicting an example of the functional configuration of the information processing device 100. In FIG. 5, the information processing device 100 includes an obtaining unit 501, a determining unit 502, an executing unit 503, a coefficient calculating unit 504, an output unit 505, and a storage unit 510.

The obtaining unit 501 to the output unit 505 function as an example of a control unit 500. For example, functions of the obtaining unit 501 to the output unit 505 are implemented by, for example, invoking the CPU 401 execute a program stored in a storage area such as the memory 402 or the recording medium 405, or by the network I/F 403. The processing results of the functional units are stored to a storage area such as the memory 402 or the recording medium 405.

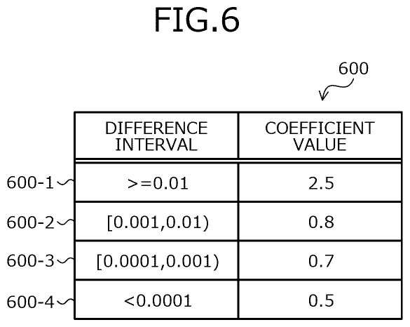

The storage unit 510 stores various information that is referred to or updated in the processes of the functional units. For example, the storage unit 510 stores a coefficient table 600 as depicted in FIG. 6. The storage unit 510 is implemented by, for example, a storage area such as the memory 402 or the recording medium 405 depicted in FIG. 4. In the following, while a case where the storage unit 510 is included in the information processing device 100 is described, configuration is not limited to this. For example, the storage unit 510 may be included in a device different from the information processing device 100 and the stored contents of the storage unit 510 may be referred to from the information processing device 100.

The obtaining unit 501 obtains various information used in the processes of the functional units. The obtaining unit 501 stores the obtained various information to the storage unit 510 or outputs the obtained information to the functional units. The obtaining unit 501 may also output the various information stored in the storage unit 510 to the functional units. The obtaining unit 501 obtains various information, for example, based on an operation input by a user. The obtaining unit 501 may receive various information, for example, from a device different from the information processing device 100.

The obtaining unit 501 obtains a processing request requesting the execution of the quantum chemical calculation using, for example, a configuration interaction method (CI method). The processing request includes information specifying a substance under analysis. The information specifying a substance under analysis indicates, for example, a combination of a molecule to be analyzed and a basis set. The basis set represents a basis function used when calculating an atomic orbital or a molecular orbital in the quantum chemical calculation. The basis set is, for example, STO-3G, 6-31G, or the like.

For example, the obtaining unit 501 obtains a processing request by receiving the processing request from another computer. The other computer is, for example, the client device 301 depicted in FIG. 3. The obtaining unit 501 may also obtain a processing request by receiving an input of the processing request.

In the following description, a case where the “FCI method” is applied as the CI method (configuration interaction method) may be described as an example. However, the CI method is not limited to the FCI method and for example, the CIFDTQ method may be applied as the CI method.

The obtaining unit 501 obtains, for example, information specifying the substance under analysis. For example, the obtaining unit 501 obtains information specifying the substance under analysis by extracting the information specifying the substance under analysis from a processing request. Also, the obtaining unit 501 may obtain information specifying the substance under analysis by receiving an input of the information specifying the substance under analysis. Also, the obtaining unit 501 may obtain information specifying the substance under analysis by receiving the information specifying the substance under analysis from another computer.

The obtaining unit 501 obtains, for example, for the substance under analysis, an absolute difference E_diff of the first energy value E1 obtained by the quantum chemical calculation using the first coupled cluster method and the second energy value E2 obtained by the quantum chemical calculation using the second coupled cluster method. Also, the obtaining unit 501 obtains, for the substance under analysis, a number-of-loops Ip of the first coupled cluster method when the first energy value E1 is obtained.

Here, the substance under analysis is identified from the obtained information specifying the substance under analysis. The second coupled cluster method is a coupled cluster method (CC method) different from the first coupled cluster method, and the maximum number of excitations, which is the number of electronic excitations to be considered, is different from that of the first coupled cluster method. The first coupled cluster method is, for example, the CCSD method. The second coupled cluster method is, for example, the CCSD(T) method.

In the following description, a case in which the “CCSD method” is applied as the first coupled cluster and the “CCSD(T) method” is applied as the second coupled cluster may be described as an example.

For example, for the substance under analysis, the obtaining unit 501 calculates the first energy value E1 by performing the quantum chemical calculation using the CCSD method. At this time, the obtaining unit 501 identifies the number-of-loops Ip of the CCSD method by which the first energy value E1 is obtained for the substance under analysis.

The obtaining unit 501 also calculates the second energy value E2 by performing the quantum chemical calculation using the CCSD(T) method, for the substance under analysis. The obtaining unit 501 then calculates the absolute difference E_diff of the calculated first energy value E1 and the second energy value E2. Then, the obtaining unit 501 obtains the calculated absolute difference E_diff and the specified number-of-loops Ip of the CCSD method.

However, the quantum chemical calculation using the CCSD method and the quantum chemical calculation using the CCSD(T) method for the substance under analysis may be executed at a computer other than the information processing device 100. In this case, the obtaining unit 501 may obtain the first energy value E1, the second energy value E2, and the number-of-loops Ip from the other computer. Then, the obtaining unit 501 may obtain the absolute difference E_diff by calculating the absolute difference E_diff of the obtained first energy value E1 and second energy value E2.

The determining unit 502 determines the maximum number-of-loops Max_loop for an instance in which the quantum chemical calculation using the FCI method is performed, for the substance under analysis, based on the first energy value E1, the second energy value E2, and the number-of-loops Ip. The maximum number-of-loops Max_loop is an upper limit value of the number of loops when an energy value is calculated by iterative calculation in the quantum chemical calculation using a CI method (e.g., the FCI method). For example, the determining unit 502 determines the maximum number-of-loops Max_loop for an instance in which the quantum chemical calculation using the FCI method is performed for the substance under analysis, based on the obtained absolute difference E_diff and number-of-loops Ip.

To describe in more detail, for example, the determining unit 502 refers to the storage unit 510 and identifies the value of a coefficient k corresponding to the obtained absolute difference E_diff. Then, the determining unit 502 determines the maximum number-of-loops Max_loop based on the obtained number-of-loops Ip and the specified coefficient k value. The determining unit 502 may determine the maximum number-of-loops Max_loop by, for example, multiplying the obtained number-of-loops Ip by the identified coefficient k value.

The storage unit 510 stores, for example, coefficient information indicating the correspondence between the value of the coefficient k and the absolute difference E_diff. The coefficient k is a coefficient used to determine the maximum number-of-loops Max_loop of the CI method (for example, the FCI method). The absolute difference E_diff indicates the absolute difference of the energy value obtained by the quantum chemical calculation using the CCSD method (first coupled cluster method) and the energy value obtained by the quantum chemical calculation using the second coupled cluster (CCSD(T)) method.

The value of the coefficient k is set so that the larger the absolute difference E_diff is, the larger the value becomes. The value of the coefficient k corresponding to the absolute difference E_diff is calculated by, for example, the coefficient calculating unit 504. However, the value of the coefficient k corresponding to the absolute difference E_diff may be manually set based on the user's operation input.

The value of the coefficient k can be expressed by, for example, a function “k=f(E_diff)” with the absolute difference E_diff as a variable. The function “k=f(E_diff)” can be implemented by, for example, a piecewise linear function.

Here, with reference to FIG. 6, the coefficient information indicating the correspondence between the value of the coefficient k and the absolute difference E_diff stored in the storage unit 510 is described, taking as an example a case where the function “k=f(E_diff)” is implemented by a piecewise linear function.

FIG. 6 is an explanatory view depicting an example of the stored contents of the coefficient table 600. In FIG. 6, the coefficient table 600 corresponds to a function “k=f(E_diff)” implemented by a piecewise linear function, expressed in table format.

The coefficient table 600 has fields for difference intervals and coefficient values, and stores coefficient information 600-1 to 600-4 as records by setting information in each field. The difference interval indicates the range of the absolute difference E_diff. The coefficient value indicates the value of the coefficient k. The coefficient value is set so that the larger the absolute difference E_diff is, the larger the value becomes.

For example, the coefficient information 600-1 indicates that the value of the coefficient k is “k=2.5” when the difference interval is “E_diff≥0.01”. Moreover, the coefficient information 600-2 indicates that the value of the coefficient k is “k=0.8” when the difference interval is “0.001≤E_diff<0.01”.

The determining unit 502, for example, refers to the coefficient table 600 to identify a difference interval including the obtained absolute difference E_diff. The determining unit 502 then identifies a value of the coefficient k corresponding to the identified difference interval. Then, the determining unit 502 determines a value obtained by multiplying the obtained number-of-loops Ip by the identified value of the coefficient k as the maximum number-of-loops Max_loop.

Here, an example of identifying the value of the coefficient k using the coefficient table 600 is described. For example, it is assumed that the absolute difference E_diff obtained for the substance under analysis is “E_diff=0.03”. In this case, the determining unit 502 refers to the coefficient table 600 to identify a difference interval “E_diff>0.01” including the absolute difference E_diff (coefficient information 600-1). Then, the determining unit 502 refers to the coefficient table 600 (coefficient information 600-1) and identifies the value “2.5” of the coefficient k corresponding to the identified difference interval “E_diff≥0.01”.

Also, assume that the absolute difference E_diff obtained for the substance under analysis is “E_diff=0.0007”. In this case, the determining unit 502 refers to the coefficient table 600 and identifies the difference interval “0.0001≤E_diff<0.001” including the absolute difference E_diff (coefficient information 600-3). Then, the determining unit 502 refers to the coefficient table 600 (coefficient information 600-3) and identifies the value “0.7” of the coefficient k corresponding to the specified difference interval “0.0001≤E_diff<0.001”.

Thus, the determining unit 502 can determine the maximum number-of-loops Max_loop based on the number-of-loops Ip so that the larger the absolute difference E_diff, the larger the value of the maximum number-of-loops Max_loop.

Note that, when determining the maximum number-of-loops Max_loop, the determining unit 502 may use the ratio between the first energy value E1 and the second energy value E2 instead of the absolute difference E_diff. For example, the determining unit 502 determines the maximum number-of-loops Max_loop depending on the ratio between the first energy value E1 and the second energy value E2 based on the number-of-loops Ip.

For example, the determining unit 502 may determine the maximum number-of-loops Max_loop based on the number-of-loops Ip according to the ratio between the first energy value E1 and the second energy value E2 so that the value of the maximum number-of-loops Max_loop increases as the second energy value E2 increases relative to the first energy value E1.

For the substance under analysis, the executing unit 503 executes a quantum chemistry calculation using the FCI method with the determined maximum number-of-loops Max_loop as the upper limit of the number-of-loops. For example, the executing unit 503 calculates an energy value by executing a quantum chemistry calculation using the FCI method by the Davidson iteration method, for the substance under analysis. At this time, the executing unit 503 sets the determined maximum number-of-loops Max_loop as the upper limit of the number-of-loops of the iterative calculation.

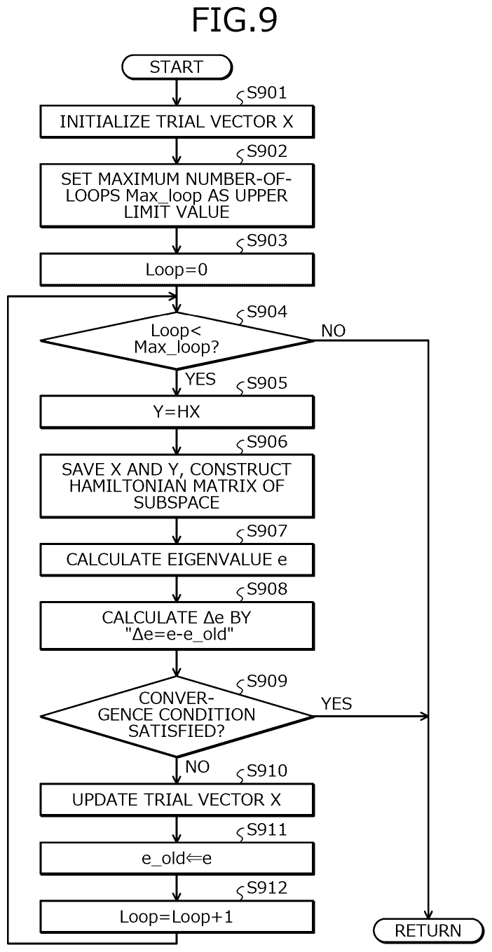

Note that the processing procedure when performing quantum chemical calculation using the FCI method by the Davidson iteration method is described later with reference to FIG. 9.

The coefficient calculating unit 504 calculates the value of a coefficient k used to determine the maximum number-of-loops Max_loop of the CI method (for example, the FCI method). The coefficient k corresponds to, for example, a value that represents the correlation between the number-of-loops of the CCSD method and the number-of-loops of the FCI method. The number-of-loops of the CCSD method is, for example, the number-of-loops when the quantum chemical calculation using the CCSD method converges. The number-of-loops of the FCI method is, for example, the number-of-loops when the quantum chemical calculation using the FCI method converges, or the number-of-loops that provides a result with the same degree of accuracy as the number-of-loops when the quantum chemical calculation using the FCI method converges.

Here, it can be said that substances having similar absolute differences E_diff (energy values of three electron excitations) have similar properties. Therefore, by deriving in advance the correlation (corresponds to the value of coefficient k) between the number of loops in the CCSD method and the number of loops in the FCI method for a certain substance, the same correlation (corresponds to the value of coefficient k) can be applied to other substances having the same or similar absolute difference E_diff.

Therefore, the coefficient calculating unit 504 obtains the correlation (corresponds to the value of coefficient k) between the number of loops in the CCSD method and the number of loops in the FCI method for each of multiple different substances, and derives the correspondence between the value of coefficient k and the absolute difference E_diff.

For example, the coefficient calculating unit 504 obtains an absolute difference E_diff_{AB} between an energy value E_{A} obtained by the quantum chemical calculation using the first coupled cluster (CCSD) method and an energy value E_{B} obtained by the quantum chemical calculation using the second coupled cluster (CCSD(T)) method for each of the different substances.

Furthermore, the coefficient calculating unit 504 obtains a number-of-loops L_{A} for an instance in which an energy value E_{A} is obtained by the quantum chemical calculation using the CCSD method (first coupled cluster method), for each of the different substances. The different substances are, for example, different atoms or molecules. Information specifying the multiple different substances is obtained by the obtaining unit 501.

More specifically, for example, the coefficient calculating unit 504 calculates the energy value E_{A} by performing the quantum chemical calculation using the CCSD method for each of the different substances. At this time, the obtaining unit 501 obtains the number-of-loops L_{A} by specifying the number of loops L_{A} of the CCSD method when the energy value E_{A} is obtained for each of the different substances.

Furthermore, the coefficient calculating unit 504 calculates the energy value E_{B} by performing the quantum chemical calculation using the CCSD(T) method, for each of the different substances. Then, the coefficient calculating unit 504 calculates the absolute difference E_diff_{AB} between the calculated energy values E_{A} and E_{B}, thereby obtaining the absolute difference E_diff_{AB}.

However, the quantum chemical calculations using the CCSD method and the CCSD(T) method for each of the different substances may be executed at a computer other than the information processing device 100. In this case, the obtaining unit 501 may obtain the energy value E_{A}, the energy value E_{B} and the number-of-loops L_{A} from another computer. Then, the obtaining unit 501 may calculate the absolute difference E_diff_{AB} between the obtained energy values E_{A} and E_{B}.

Furthermore, the coefficient calculating unit 504 specifies a minimum number-of-loops Lₘᵢₙ of the FCI method that obtains an energy value that falls within an allowable range of error from an energy value E_{FCI} obtained using the FCI method for each of the multiple different substances. The allowable range of error can be set arbitrarily, for example, to about 10⁻⁵ or less.

For example, the coefficient calculating unit 504 calculates the energy value E_{FCI} by performing the quantum chemical calculation using the FCI method, for each of the different substances. Here, the allowable range of error is set to “10⁻⁵ or less”. In this case, the coefficient calculating unit 504 specifies the minimum number-of-loops Lₘᵢₙ at which an energy value with an error of 10⁻⁵ or less from the energy value E_{FCI} is obtained in the quantum chemical calculation using the FCI method, for each of the different substances.

More specifically, for example, the coefficient calculating unit 504 records, for each of the different substances, energy values calculated during the process until the energy value E_{FCI} is obtained in the quantum chemical calculation using the FCI method, the calculated energy values and the number-of-loops at that time being associated and recorded with each other. Then, for each substance, the coefficient calculating unit 504 may refer to the energy values and the number-of-loops associated and recorded with each other and identify the minimum number-of-loops Lₘᵢₙ as the minimum number-of-loops when an energy value with an error of 10⁻⁵ or less from the obtained energy value E_{FCI} is calculated.

The coefficient calculating unit 504 may repeat the execution of the quantum chemical calculation using the FCI method while changing the maximum number-of-loops for each substance within a range smaller than a number-of-loops L_{FCI} when the energy value E_{FCI} is obtained. As described, the coefficient calculating unit 504 may search for the minimum number-of-loops Lₘᵢₙ at which an energy value with an error of 10⁻⁵ or less from the energy value E_{FCI} is obtained.

After calculating the energy value E_{FCI} for each substance, the coefficient calculating unit 504 may set the convergence condition to “an energy value with an error of 10⁻⁵ or less from the energy value E_{FCI} has been calculated” and execute the quantum chemical calculation using the FCI method again. In this case, the coefficient calculating unit 504 may specify, as the minimum number-of-loops Lₘᵢₙ, the number-of-loops when the set convergence condition is satisfied.

The coefficient calculating unit 504 then calculates the value of the coefficient k for each of the different substances, based on the obtained number-of-loops L_{A} and the specified minimum number-of-loops Lₘᵢₙ. For example, the coefficient calculating unit 504 may calculate the value of the coefficient k by dividing the minimum number-of-loops Lₘᵢₙ by the number-of-loops L_{A}.

The coefficient calculating unit 504 then creates coefficient information, based on the correspondence between the value of the coefficient k calculated for each substance and the absolute difference E_diff_{AB} obtained for each substance. Then, the coefficient calculating unit 504 stores the created coefficient information to the storage unit 510. For example, the coefficient calculating unit 504 may create a function “k=f(E_diff)” based on the correspondence between the value of the coefficient k for each substance and the absolute difference E_diff_{AB}.

The function “k=f(E_diff)” is a function that expresses the value of the coefficient k with the absolute difference E_diff as a variable. The function “k=f(E_diff)” is implemented by, for example, a piecewise linear function. In this case, for each of the multiple difference intervals, the coefficient calculating unit 504 identifies a substance that, among the different substances, includes the difference absolute value E_diff_{AB} in the difference interval.

The multiple difference intervals are intervals obtained by dividing the entire range of values that can be taken as the difference absolute value E_diff. Each difference interval indicates a range of the difference absolute value E_diff. The coefficient calculating unit 504 then creates coefficient information that indicates a correspondence relationship between each of the multiple difference intervals and the value of the coefficient k calculated for the identified substance. Then, the coefficient calculating unit 504 stores the created coefficient information to the coefficient table 600.

Also, for each of the multiple difference intervals, two or more substances that include the difference absolute value E_diff_{AB} in the difference interval may be identified. In this case, the coefficient calculating unit 504 may create coefficient information that indicates a correspondence relationship between the difference interval and the maximum coefficient k value among the values of coefficient k calculated for each of the two or more substances.

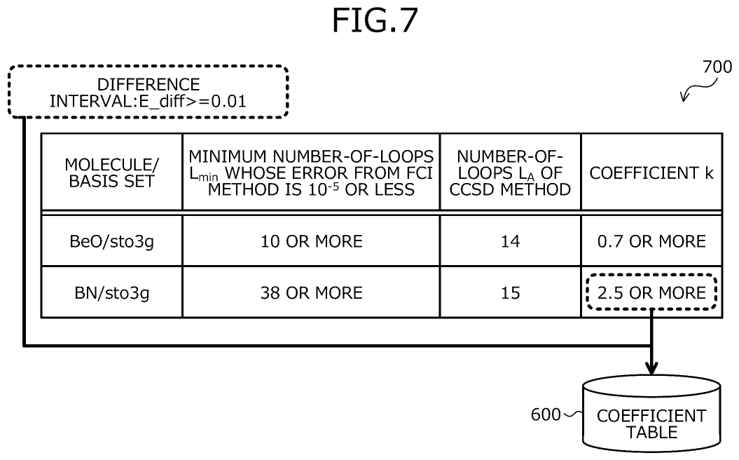

An example of calculation of the value of the coefficient k corresponding to each of the multiple difference intervals is described later with reference to FIG. 7. In addition, although the function “k=f(E_diff)” is implemented by a piecewise linear function here, the present invention is not limited to hereto. For example, the function “k=f(E_diff)” may be implemented by a linear function. In addition, the correspondence between the value of the coefficient k and the absolute difference E_diff may be derived by machine learning.

The output unit 505 outputs the processing result of at least any one of the functional units. The output format is, for example, display on a display (not depicted), print output to a printer (not depicted), transmission to an external device by the network I/F 403, or storage to a storage area such as the memory 402 or the recording medium 405.

The output unit 505, for example, associates and outputs the execution result of the quantum chemical calculation using the FCI method and the substance under analysis. The execution result includes an energy value for the substance under analysis calculated by performing the quantum chemical calculation using the FCI method.

Furthermore, the output unit 505 may associate and output the determined maximum number-of-loops Max_loop and the substance under analysis, for example. In this case, for example, at a computer other than the information processing device 100, the quantum chemical calculation using the FCI method may be performed for the substance under analysis with the maximum number-of-loops Max_loop output from the information processing device 100, as the upper limit value of the number-of-loops.

In the above description, while the first coupled cluster method is the “CCSD method” and the second coupled cluster method is the “CCSD(T) method”, this is not limitative. For example, the first coupled cluster method may be the “CCS method” and the second coupled cluster method may be the “CCSD method”. Also, the first coupled cluster method may be the “CCSD(T) method”, and the second coupled cluster method may be the “CCSDT(Q) method”.

An example of calculation of coefficient k corresponding to difference interval is described next.

Here, an example is described in which the function “k=f(E_diff)” is implemented by a piecewise linear function. Also, the multiple difference intervals are “E_diff>0.01”, “0.001≤E_diff<0.01”, “0.0001≤E_diff<0.001” and “E_diff<0.0001”.

The coefficient calculating unit 504 calculates, for each of the multiple different substances, an absolute difference E_diff_{AB} between an energy value E_{A} obtained by the quantum chemical calculation using the CCSD method and an energy value E_{B} obtained by the quantum chemical calculation using the CCSD(T) method. Furthermore, the coefficient calculating unit 504 obtains, for each of the multiple different substances, the number-of-loops L_{A} when the energy value E_{A} is obtained by the quantum chemical calculation using the CCSD method.

Here, the multiple different substances are assumed to be “BeO/sto3g”, “BN/sto3g”, “CO/sto3g”, “N2/sto3g”, “BeH2/sto3g”, “O2/sto3g”, “H2O/sto3g”, and “H2S/sto3g”. In this case, for each of the multiple difference intervals, the coefficient calculating unit 504 identifies, from among these eight substances, a substance (molecule/basis set) whose absolute difference E_diff_{AB} is included in the difference interval.

With reference to FIG. 7, a calculation example of the value of the coefficient k corresponding to the difference interval “E_diff>0.01” is described, taking the difference interval “E_diff≥0.01” as an example.

FIG. 7 is an explanatory view depicting a calculation example of the value of the coefficient k corresponding to a difference interval. The coefficient calculating unit 504 identifies molecules whose absolute differences E_diff_{AB} are 0.01 or more from among the above-mentioned eight substances. Here, it is assumed that “BeO/sto3g” and “BN/sto3g” are identified as molecules whose absolute differences E_diff_{AB} are 0.01 or more.

In FIG. 7, table 700 depicts various information related to “BeO/sto3g” and “BN/sto3g”. The coefficient calculating unit 504 identifies the number-of-loops L_{A} in the CCSD method for a case where the energy value E_{A} is obtained for the identified molecule “BeO/sto3g”. Here, it is assumed that the number-of-loops L_{A} for the molecule “BeO/sto3g” is “L_{A}=14”.

Furthermore, the coefficient calculating unit 504 identifies, for “BeO/sto3g”, the minimum number-of-loops Lₘᵢₙ that can obtain an energy value that has an error within an allowable range from the energy value E_{FCI} that is obtained using the FCI method. However, the allowable range is “10⁻⁵ or less”. Here, it is assumed that the minimum number of loops Lₘᵢₙ for “BeO/sto3g” is “Lₘᵢₙ=10”.

Then, the coefficient calculating unit 504 calculates the value of the coefficient k for “BeO/sto3g” by dividing the minimum number-of-loops Lₘᵢₙ by the number-of-loops L_{A}. Here, the value of the coefficient k is “k=0.7 (˜10÷14)”. From this, the coefficient calculating unit 504 knows that for “BeO/sto3g”, in order to suppress the error with the conventional FCI method to 10⁻⁵ or less, the coefficient calculating unit 504 should set the value of the coefficient k to 0.7 or more.

Similarly, for the identified molecule “BN/sto3g”, the coefficient calculating unit 504 identifies the number-of-loops L_{A} of the CCSD method in a case where the energy value E_{A} is obtained. Here, it is assumed that the number-of-loops L_{A} for “BN/sto3g” is “L_{A}=15”.

Furthermore, for “BN/sto3g”, the coefficient calculating unit 504 identifies the minimum number-of-loops Lₘᵢₙ that can obtain an energy value that has an error within an allowable range from the energy value E_{FCI} that is obtained using the FCI method. Here, it is assumed that the minimum number-of-loops Lₘᵢₙ for “BN/sto3g” is “Lₘᵢₙ=3.8”.

Then, the coefficient calculating unit 504 calculates the value of the coefficient k for “BN/sto3g” by dividing the minimum number-of-loops Lₘᵢₙ by the number-of-loops L_{A}. Here, the value of the coefficient k is “k=2.5 (˜38÷15)”. From this, the coefficient calculating unit 504 knows that for “BN/sto3g”, in order to suppress the error with the conventional FCI method to 10⁻⁵ or less, the coefficient calculating unit 504 should set the value of the coefficient k to 2.5 or more.

Then, the coefficient calculating unit 504 identifies the maximum coefficient k value “k=2.5” from among the coefficient k values calculated for “BeO/sto3g” and “BN/sto3g”. Then, the coefficient calculating unit 504 associated and stores the identified coefficient k value “k=2.5” and the difference interval “E_diff>0.01” to the coefficient table 600. As a result, coefficient information 600-1, as depicted in FIG. 6, is stored as a record in the coefficient table 600.

Although not depicted, for the difference interval “0.001≤E_diff<0.01”, “CO/sto3g” and “N2/sto3g” are identified, and the value “k=0.8” of coefficient k is calculated. In this case, the coefficient calculating unit 504 associates the value of coefficient k with the difference interval “0.001≤E_diff<0.01” and stores the value of coefficient k to the coefficient table 600. As a result, coefficient information 600-2, as depicted in FIG. 6, is stored as a record in the coefficient table 600.

Furthermore, for the difference interval “0.0001≤E_diff<0.001”, “BeH2/sto3g” and “O2/sto3g” are identified, and the value “k=0.7” of coefficient k is calculated. In this case, the coefficient calculating unit 504 associates the value of coefficient k with the difference interval “0.0001≤E_diff<0.001” and stores the value of coefficient k to the coefficient table 600. As a result, coefficient information 600-3, as depicted in FIG. 6, is stored as a record in the coefficient table 600.

Furthermore, for the difference interval “E_diff<0.0001”, “H2O/sto3g” and “H2S/sto3g” are identified, and the value “k=0.5” of coefficient k is calculated. In this case, the coefficient calculating unit 504 associates the value of the coefficient k, “k=0.5”, with the difference interval “E_diff<0.0001” and stores the value of the coefficient k to the coefficient table 600. As a result, the coefficient information 600-4, as depicted in FIG. 6, is stored as a record in the coefficient table 600.

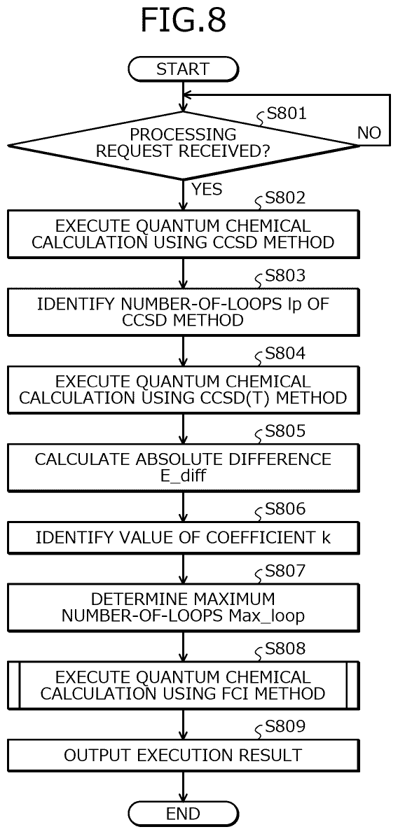

A procedure of a number-of-loops adjustment process of the information processing device 100 is described with reference to FIG. 8.

FIG. 8 is a flowchart depicting an example of the procedure of the number-of-loops adjustment process of the information processing device 100. In the flowchart de3picted in FIG. 8, first, the information processing device 100 determines whether a processing request for executing the quantum chemical calculation using the FCI method has been received (step S801).

Here, the information processing device 100 waits for a processing request to be received (step S801: NO). When the information processing device 100 receives a processing request (step S801: YES), the information processing device 100 calculates, for the substance under analysis, the first energy value E1 by performing the quantum chemical calculation using the CCSD method (step S802).

Then, the information processing device 100 identifies the number-of-loops Ip of the CCSD method by which the first energy value E1 is obtained for the substance under analysis (step S803). Next, the information processing device 100 calculates, for the substance under analysis, the second energy value E2 by performing the quantum chemical calculation using the CCSD(T) method (step S804).

Then, the information processing device 100 calculates the absolute difference E_diff of the calculated first energy value E1 and the second energy value E2 (step S805). The information processing device 100 then refers to the coefficient table 600 and identifies the value of the coefficient k corresponding to the difference interval including the calculated absolute difference E_diff (step S806).

Then, the information processing device 100 determines the maximum number-of-loops Max_loop, based on the identified number-of-loops Ip and the identified value of the coefficient k (step S807). For example, the information processing device 100 determines the maximum number-of-loops Max_loop to be a value obtained by multiplying the number-of-loops Ip by the value of the coefficient k.

The information processing device 100 then executes, for the substance under analysis, the quantum chemical calculation using the FCI method with the determined maximum number-of-loops Max_loop as the upper limit value of the number-of-loops (step S808). Note that a specific processing procedure of the quantum chemical calculation using the FCI method is described later with reference to FIG. 9.

Then, the information processing device 100 associates and outputs the substance under analysis and the result of executing the quantum chemical calculation using the FCI method (step S809), and ends a series of processes according to this flowchart. The result includes, for example, an eigenvalue e (energy value) calculated at step S907 depicted in FIG. 9 described later.

This enables the information processing device 100 to adjust the maximum number-of-loops Max_loop in the quantum chemical calculation using the FCI method.

A specific processing procedure of the quantum chemical calculation using the FCI method at step S808 is described next with reference to FIG. 9. Here, a case where the quantum chemical calculation using the FCI method is performed by the Davidson iteration method is described.

FIG. 9 is a flowchart depicting an example of a specific processing procedure of the quantum chemical calculation using the FCI method. In the flowchart depicted in FIG. 9, first, the information processing device 100 initializes a trial vector X (step S901). Note that the information processing device 100 may generate an initial value of the trial vector X by a random number, or may set all to 0.

Then, the information processing device 100 sets the maximum number-of-loops Max_loop determined at step S807 depicted in FIG. 8 as the upper limit value of the number-of-loops Loop (step S902). The information processing device 100 then sets the number-of-loops Loop to “Loop=0” (step S903), and judges whether the number-of-loops Loop is smaller than the maximum number-of-loops Max_loop (step S904).

When the number-of-loops Loop is smaller than the maximum number-of-loops Max_loop (step S904: YES), the information processing device 100 generates Y by “Y=HX” (step S905). H is a Hamiltonian operator corresponding to the subspace. For example, H calculated by the Hartree-Fock method is used. Y is a vector generated by multiplying H by X.

The information processing device 100 then saves X and Y, and constructs a Hamiltonian matrix of the subspace from X and Y (step S906). Then, the information processing device 100 calculates an eigenvalue e (energy value) by diagonalizing the constructed Hamiltonian matrix (step S907).

The information processing device 100 then calculates Δe by “Δe=e−e_old” (step S908). Then, the information processing device 100 judges whether a predetermined convergence condition is satisfied (step S909). The convergence condition is, for example, “Δe<tol” and “max_dx_norm<sqrt(tol)”. tol is 10⁻¹². max_dx_norm is a result of normalization of the residual vector based on the trial vector X.

When the convergence condition is not satisfied (step S909: NO), the information processing device 100 updates the trial vector X so as to obtain a lower energy value (step S910). Next, the information processing device 100 updates e_old with the calculated eigenvalue e (step S911).

Then, the information processing device 100 increments the number-of-loops Loop (step S912) and returns to step S904. At step S904, when the number-of-loops Loop is equal to or greater than the maximum number-of-loops Max_loop (step S904: NO), the information processing device 100 returns to the step where the quantum chemical calculation using the FCI method was invoked.

In addition, at step S909, when the convergence condition is satisfied (step S909: YES), the information processing device 100 returns to the step where the quantum chemical calculation using the FCI method was invoked.

As a result, the information processing device 100 can limit the maximum number-of-loops Max_loop as compared to the conventional method while maintaining the accuracy of the quantum chemical calculation using the FCI method, thereby shortening the execution time.

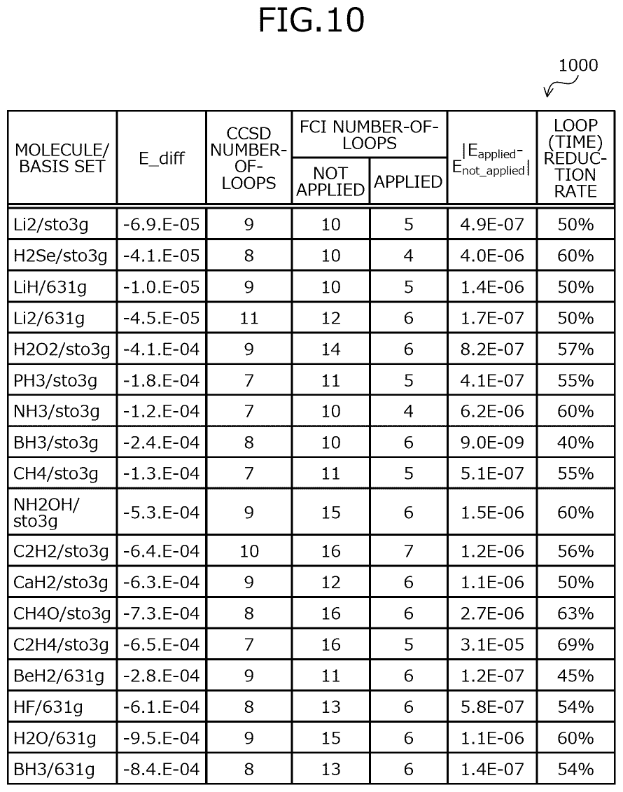

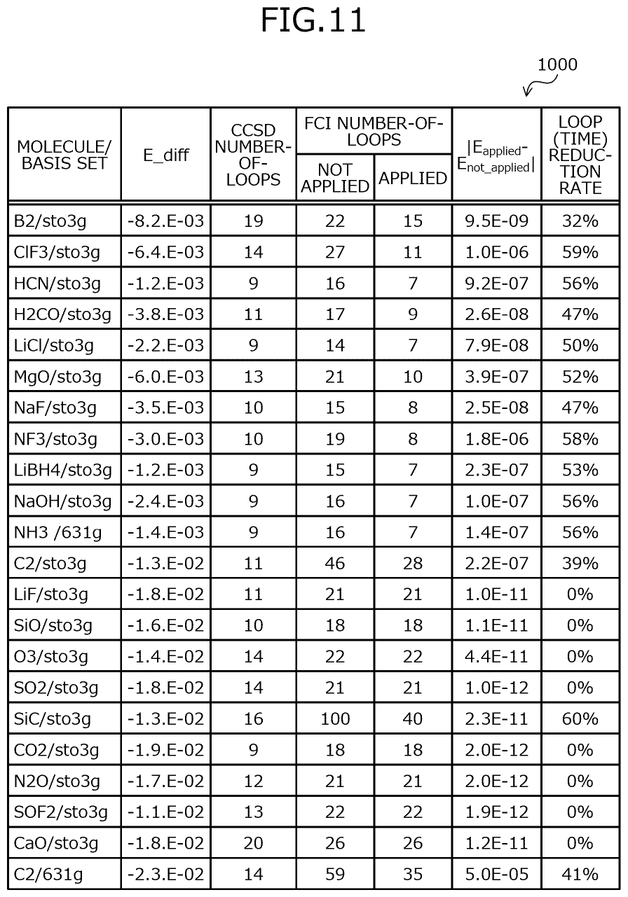

With reference to FIGS. 10 and 11, an example of a reduction in the execution time required for quantum chemical calculation using the FCI method when the number-of-loops adjustment method according to the embodiment is applied is described.

FIGS. 10 and 11 are explanatory views depicting an example of a reduction in the execution time when the present number-of-loops adjustment method is applied. In FIGS. 10 and 11, the number-of-loops adjustment result 1000 indicates E_diff, the number of CCSD loops, the number of FCI loops (not applied, applied), |E_{applied}−E_{not_applied}|, and the loop reduction rate for each molecule (molecule/basis set).

The molecule (molecule/basis set) is an example of the substance under analysis. E_diff indicates the absolute difference (E_diff) between the energy value (E1) obtained using the CCSD method and the energy value (E2) obtained using the CCSD(T) method, for each molecule (molecule/basis set). The CCSD number-of-loops is the number-of-loops (Ip) of the CCSD method, for each molecule (molecule/basis set).

The FCI number-of-loops (not applied) is the number-of-loops when the energy value is obtained for each molecule (molecule/basis set) by the conventional FCI method when the present number-of-loops adjustment method is not applied. The FCI number-of-loops (applied) is the number-of-loops when the energy value is obtained for each molecule (molecule/basis set) by the FCI method when the present number-of-loops adjustment method is applied.

|E_{applied}−E_{not_applied}| indicates the error between the energy value obtained for each molecule (molecule/basis set) by the FCI method when the present number-of-loops adjustment method is applied and the energy value obtained by the conventional FCI method when the present number-of-loops adjustment method is not applied. The loop reduction ratio indicates the ratio of the number of loops reduced when the present number-of-loops adjustment method is applied as compared to the conventional FCI method.

According to the number-of-loops adjustment result 1000, it is found that by applying the present number-of-loops adjustment method, it is possible to maintain the accuracy of quantum chemical calculations using the FCI method while shortening the execution time. In the example of the number-of-loops adjustment result 1000, it is found that the error in the energy value when the present number-of-loops adjustment method is applied is suppressed to about 10⁻⁵ or less. In addition, in the example of the number-of-loops adjustment result 1000, it is found that the number of loops in the FCI method can be reduced by about 40% on average and maximally by 69% as compared to the conventional method.

As described above, according to the information processing device 100 of the embodiment, the maximum number-of-loops Max_loop when performing the quantum chemical calculation using the FCI method can be determined based on the first energy value E1 obtained by the quantum chemical calculation using the CCSD method, the second energy value E2 obtained by the quantum chemical calculation using the CCSD(T) method, and the number-of-loops Ip of the CCSD method by which the first energy value E1 is obtained for the substance under analysis.

As a result, the information processing device 100 can adjust the maximum number-of-loops Max_loop in the quantum chemical calculation that uses the FCI method. For example, the information processing device 100 can adjust the maximum number-of-loops Max_loop so that the maximum number-of-loops Max_loop does not become too large, thereby shortening the execution time required for the quantum chemical calculation using the FCI method. Moreover, by adjusting the maximum number-of-loops Max_loop so that the maximum number-of-loops Max_loop does not become excessively smaller than necessary, the information processing device 100 can maintain the accuracy of the quantum chemical calculation that uses the FCI method.

Moreover, according to the information processing device 100, the maximum number-of-loops Max_loop can be determined based on the absolute difference E_diff of the first energy value E1 and the second energy value E2 and the number-of-loops lp.

As a result, the information processing device 100 can adjust the maximum number-of-loops Max_loop taking into consideration whether the electrons are activated.

Moreover, according to the information processing device 100, the quantum chemical calculation using the FCI method can be performed for the substance under analysis with the determined maximum number-of-loops Max_loop as the upper limit value of the number-of-loops.

As a result, the information processing device 100 can shorten the execution time required for the quantum chemical calculation while maintaining the accuracy of the quantum chemical calculation using the FCI method.

According to the information processing device 100, the value of the coefficient k corresponding to the absolute difference E_diff can be identified by referring to the storage unit 510. The storage unit 510 stores coefficient information indicating the correspondence between the value of the coefficient k used to determine the maximum number-of-loops Max_loop of FCI and the absolute difference E_diff. The absolute difference E_diff indicates the absolute difference between the energy value obtained by the quantum chemical calculation using the CCSD method and the energy value obtained by the quantum chemical calculation using the CCSD(T) method. According to the information processing device 100, the maximum number-of-loops Max_loop can be determined based on the obtained number-of-loops Ip and the identified value of the coefficient k.

Thus, the information processing device 100 can adjust the maximum number-of-loops Max_loop by using the value of the coefficient k according to the magnitude of the energy value (absolute difference E_diff) of the three electron excitations. For example, the information processing device 100 can determine the maximum number-of-loops Max_loop based on the number-of-loops Ip so that the value of the maximum number-of-loops Max_loop increases as the energy value of the three electron excitations increases. Also, the information processing device 100 can determine the maximum number-of-loops Max_loop based on the number-of-loops Ip so that the value of the maximum number-of-loops Max_loop decreases as the energy value of the three electron excitations decreases.

Also, according to the information processing device 100, the absolute difference E_diff_{AB} and the number-of-loops L_{A} can be obtained for each of multiple different substances. The absolute difference E_diff_{AB} represents the absolute difference between the energy value E_{A} obtained by the quantum chemical calculation using the CCSD method and the energy value E_{B} obtained by the quantum chemical calculation using the CCSD(T) method for each substance. The number-of-loops L_{A} represents the number of loops when the energy value E_{A} is obtained by using the CCSD method, for each substance. Moreover, according to the information processing device 100, for each substance, it is possible to identify the minimum number-of-loops Lₘᵢₙ of the FCI method that can obtain an energy value that is within an allowable range of error from the energy value E_{FCI} that is obtained by quantum chemical calculation using the FCI method. Furthermore, according to the information processing device 100, for each substance, it is possible to calculate the value of the coefficient k based on the obtained number-of-loops L_{A} and the identified minimum number-of-loops Lₘᵢₙ. Further, according to the information processing device 100, it is possible to create coefficient information based on the correspondence between the absolute difference E_diff_{AB} obtained for each substance and the coefficient k value calculated for each substance, and to store the created coefficient information in the storage unit 510.

As a result, the information processing device 100 can derive the correspondence between the value of the coefficient k and the absolute difference E_diff using multiple different substances and can identify the value of the coefficient k according to a property represented by the absolute difference E_diff, for the substance under analysis.

According to the information processing device 100, it is possible to create coefficient information that indicates the correspondence between each of the multiple difference intervals and the value of the coefficient k calculated for a substance among multiple different substances, the difference interval of which includes the absolute difference E_diff_{AB}. According to the information processing device 100, it is possible to refer to the storage unit 510 to identify the value of the coefficient k corresponding to the difference interval that, among the multiple difference intervals, includes the absolute difference E_diff obtained for the substance under analysis, and to determine the maximum number-of-loops Max_loop based on the number-of-loops Ip obtained for the substance under analysis and the identified value of the coefficient k.

Thus, the information processing device 100 can express the correspondence between the value of the coefficient k and the absolute difference E_diff by a piecewise linear function, and can identify the value of the coefficient k according to the property classified by the absolute difference E_diff, for the substance under analysis.

According to the information processing device 100, when there are two or more substances in each of multiple difference intervals among multiple different substances, each of which includes a difference absolute value E_diff_{AB}, it is possible to create coefficient information that represents a correspondence relationship between the difference interval and the maximum coefficient k value among the coefficient k values calculated for each of the two or more substances.

As a result, the information processing device 100 can accurately derive the value of the coefficient k corresponding to the difference interval.

According to the information processing device 100, it is possible to associate and output the substance under analysis and the result of executing the quantum chemical calculation using the FCI method.

Thus, the information processing device 100 can provide an energy value calculated by the quantum chemical calculation using the FCI method, for the substance under analysis.

Thus, according to the information processing device 100, it is possible to provide highly accurate energy values calculated by the quantum chemical calculation using the FCI method for various substances, and it is possible to analyze molecular structures, material properties, reactivity, and the like. The information processing device 100 can also use the results of the quantum chemical calculation using the FCI method as a standard of accuracy for other quantum chemical calculation methods. The information processing device 100 can reduce the number of loops to shorten the execution time, so that it is possible to suppress the power consumption required for the quantum chemical calculation. The number-of-loops adjustment method can be applied to, for example, material development. In this case, the information processing device 100 can shorten the execution time of the quantum chemical calculation required for material development, thereby reducing the cost required for experiments and verification in the material development.

The number-of-loops adjustment method described in the present embodiment may be implemented by executing a prepared program on a computer such as a personal computer and a workstation. The number-of-loops adjustment program is stored on a non-transitory, computer-readable recording medium such as a hard disk, a flexible disk, a compact-disc read-only memory (CD-ROM), a digital versatile disk (DVD), a universal serial bus (USB) memory, or the like, is read out from the computer-readable medium and executed by the computer. The number-of-loops adjustment program may be distributed through a network such as the Internet.

The information processing device 100 described in the present embodiment can be realized by an application specific integrated circuit (ASIC) such as a standard cell or a structured ASIC, or a programmable logic device (PLD) such as a field-programmable gate array (FPGA).

According to one aspect of the present invention, an effect can be achieved in that it becomes possible to adjust the maximum number of loops in quantum chemical calculations using the configuration interaction (CI) method.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium storing therein a number-of-loops adjustment program for causing a computer to execute a process, the process comprising:
determining a maximum number-of-loops when a quantum chemical calculation using a configuration interaction method is executed for a substance under analysis, the maximum number-of-loops being determined based on: a first energy value obtained by the quantum chemical calculation using a first coupled cluster method for the substance under analysis, a second energy value obtained by the quantum chemical calculation using a second coupled cluster method having a different maximum excitation count from the first coupled cluster method for the substance under analysis, and a number-of-loops of the first coupled cluster method when the first energy value is obtained.

2. The recording medium according to claim 1, wherein
the determining includes determining the maximum number-of-loops based on the number-of-loops and an absolute difference of a difference of the first energy value and the second energy value.

3. The recording medium according to claim 1, the process comprising:
executing, for the substance under analysis, the quantum chemical calculation using the configuration interaction method with the determined maximum number-of-loops being an upper limit value of the number-of-loops.

4. The recording medium according to claim 1, wherein
the determining includes:
referring to a storage unit that stores coefficient information indicating a correspondence relationship between a value of a coefficient used in determining the maximum number-of-loops of the configuration interaction method and an absolute difference of an energy value obtained by the quantum chemical calculation using the first coupled cluster method and an energy value obtained by the quantum chemical calculation using the second coupled cluster method, to thereby identify a value of the coefficient corresponding to the absolute difference of the first energy value and the second energy value; and
determining the maximum number-of-loops based on the number-of-loops and the identified value of the coefficient.

5. The recording medium according to claim 4, wherein the substance under analysis is one of a plurality of substances that are mutually different,
the process comprising for each of the plurality of substances:
obtaining the absolute difference of the energy value obtained by the quantum chemical calculation using the first coupled cluster method and the energy value obtained by the quantum chemical calculation using the second coupled cluster method; and the number-of-loops of the first coupled cluster method when the energy value is obtained by the quantum chemical calculation using the first coupled cluster method;
identifying a minimum number-of-loops of the configuration interaction method resulting in an energy value whose error from the energy value obtained by the quantum chemical calculation using the configuration interaction method is within an allowable range;
calculating the value of the coefficient based on the obtained number-of-loops and the identified minimum number-of-loops;
creating the coefficient information based on a correspondence relationship between the absolute difference obtained for the each of the plurality of substances and the calculated value of the coefficient for the each of the plurality of substances; and
storing the created coefficient information to the storage unit.

6. The recording medium according to claim 5, wherein
the creating includes creating the coefficient information indicating a correspondence relationship between each of a plurality of difference intervals and the value of the coefficient calculated for a substance that, among the plurality of substances, includes the obtained absolute difference in the each difference interval, and
the determining includes referring to the storage unit to thereby identify the value of the coefficient corresponding to a difference interval that, among the plurality of difference intervals, includes the absolute difference of the first energy value and the second energy value for the substance under analysis, and determining the maximum number-of-loops based on the number-of-loops of the substance under analysis and the identified value of the coefficient.

7. The recording medium according to claim 6, wherein
when there are two or more substances that, among the plurality of substances, include the obtained absolute difference in the each difference interval, the creating includes creating coefficient information indicating a correspondence relationship between the each difference interval and a maximum value of the value of the coefficient, calculated for each of the two or more substances.

8. The recording medium according to claim 3, the process comprising:
associating and outputting the substance under analysis and a result of execution of the quantum chemical calculation executed using the configuration interaction method.

9. The recording medium according to claim 1, wherein
the first coupled cluster method is a CCSD method,
the second coupled cluster method is a CCSD method, and
the configuration interaction method is an FCI method.

10. A number-of-loops adjustment method executed by a computer to execute a process, the method comprising:
determining a maximum number-of-loops when a quantum chemical calculation using a configuration interaction method is executed for a substance under analysis, the maximum number-of-loops being determined based on: a first energy value obtained by the quantum chemical calculation using a first coupled cluster method for the substance under analysis, a second energy value obtained by the quantum chemical calculation using a second coupled cluster method having a different maximum excitation count from the first coupled cluster method for the substance under analysis, and a number-of-loops of the first coupled cluster method when the first energy value is obtained.

11. A number-of-loops adjustment device, comprising:
a memory; and
a processor coupled to the memory, the processor configured to:
determine a maximum number-of-loops when a quantum chemical calculation using a configuration interaction method is executed for a substance under analysis, the maximum number-of-loops being determined based on: a first energy value obtained by the quantum chemical calculation using a first coupled cluster method for the substance under analysis, a second energy value obtained by the quantum chemical calculation using a second coupled cluster method having a different maximum excitation count from the first coupled cluster method for the substance under analysis, and a number-of-loops of the first coupled cluster method when the first energy value is obtained.
